(19) United States
(12) Patent Application Publication
(10) Pub. No.: US 2025/0050279 A1
(43) Pub. Date: Feb. 13, 2025

(54) FILTER MEMBER AND FILTER STRUCTURE INCLUDING SAME

(71) Applicant: COWAY CO., LTD., Gongju-si (KR)

(72) Inventors: Geun Sang RYU, Gongju-si (KR); Tae Hun MOON, Gongju-si (KR); Sung Han YUN, Gongju-si (KR); Doo Won HAN, Gongju-si (KR); Jung Hun LEE, Gongju-si (KR)

(73) Assignee: COWAY CO., LTD., Gongju-si (KR)

(21) Appl. No.: 18/722,177

(22) PCT Filed: Nov. 22, 2022
(86) PCT No.: PCT/KR2022/018533

§ 371 Date: Jun. 20, 2024

(30) Foreign Application Priority Data
Dec. 22, 2021 (KR) 10-2021-0184977

(51) Int. Cl. B01D 63/10; B01D 61/02; B01D 61/04; C02F 1/44

(52) U.S. Cl. CPC B01D 63/101; B01D 61/025; B01D 61/04; C02F 1/441; B01D 2311/04

(57) ABSTRACT

A filter member including a cylinder part extending in one direction, a filter hollow part which is formed inside the cylinder part to pass through along the one direction and allows the inside of the cylinder part to be in communication along the one direction, and a filtering part disposed to surround the cylinder part from radially outside and configured to filter raw water flowing through the filter hollow part.

### TECHNICAL FIELD

The present invention relates to a filter member and a filter structure including the same, and to a filter member with a structure in which a flow path flowing into the filter member can be formed in various ways and a filter structure including the same.

### BACKGROUND

A water purifier refers to an apparatus that receives raw water from outside, filters it to the water quality desired by the user, and discharges it. As interest in improving health and quality of life increases, there is an increasing demand to drink clean water by installing a water purifier not only in public places such as offices but also in homes.

Water purifiers are generally equipped with a filter as a member for filtering raw water. Filters generate purified water by filtering foreign substances and components mixed in raw water in a physical and chemical manner. The generated purified water may be discharged to the outside by a user's manipulation or the like so that the user may drink it.

Among the types of filters widely used recently, there is a reverse osmosis filter. Reverse osmosis filters filter raw water by using the concentration difference between raw water and purified water in reverse. Specifically, a reverse osmosis filter generates purified water by forcing raw water to pass through a filter and filtering out foreign substances mixed in the raw water.

Reverse osmosis filters are equipped with a thin film member called a membrane. The membrane is wound while surrounding the body of the reverse osmosis filter, and at this time, a minute space is formed between each layer formed by the membrane. Raw water flows into the interior of the reverse osmosis filter through the space and is filtered as purified water.

Referring to FIG. 13, a filter member 1000 according to the related art is shown. As shown, the filter member 1000 includes a cylinder 1100 forming its body and a valve 1200 connected to the cylinder 1100 and wound around the cylinder 1100. As described above, raw water flows from the lower side to the upper side and enters the inside of the filter member 1000 (arrow in (b) of FIG. 13).

The entering raw water flows through the space between the valves 1200 wound around the cylinder 1000, flows toward the center of the cylinder 1000, and is filtered.

Foreign substances separated from raw water accumulate inside the filter member 1000. In this case, the raw water flow (R.F) is formed in a single direction from the lower side to the upper side of the filter member 1000.

Therefore, the separated foreign substances flow together with the raw water flow (R.F) passing through the filter member 1000 and mainly accumulates on the downstream side, that is, on the upper side in the example shown.

Therefore, based on the direction of the raw water flow (R.F), the concentration of accumulated foreign substances increases from the upstream side to the downstream side ((a) in FIG. 14).

Meanwhile, raw water may flow through the filter member 1000 by the raw water pressure applied from the upstream side, that is, the lower side of the filter member 1000. As the raw water flows upward of the filter member 1000, the raw water pressure, that is, the force for flowing the raw water, gradually decreases, and the flow rate of the flowing raw water also decreases.

As the flow rate of raw water decreases, the force for pressing and discharging the accumulated foreign substances to the outside of the filter member 1000 also decreases. Accordingly, a dead space in which a large amount of foreign substances are accumulated is formed on the downstream side of the raw water flow (R.F), that is, on the upper part of the filter member 1000.

In the dead space, it is difficult to smoothly form the raw water flow (R.F) due to the large amount of accumulated foreign substances. In addition, as the concentration of foreign substances accumulated in the dead space increases, TDS Creep (Total Dissolved Solids Creep) phenomenon may occur, that is, due to the osmotic pressure, a phenomenon in which accumulated foreign substances face filtered purified water for concentration equilibrium may occur.

In this case, if the user proceeds to discharge purified water, there is a possibility that a fluid containing foreign substances may be discharged.

In addition, if the accumulation of foreign substances becomes excessive, cleaning and maintenance of the filter member 1000 may become difficult. This is due to the fact that the fluid supplied for cleaning the filter member 1000 also flows only in one direction, similar to the raw water flow (R.F). The above-described problem may cause a decrease in filtration efficiency and reliability of the filter member 1000.

Chinese Patent Laid-open Publication No. 111185097 discloses a membrane module, a composite filter element group, and a water purification system. Specifically, it discloses a membrane module, composite filter element group, and water purification system in which filtration is performed using a spiral-wound membrane wound around a central tube, wherein the spiral-wound membranes are formed as a pair and wound around the central tube.

However, the membrane module, etc. disclosed in the above prior literature merely presents a method for forming a plurality of discharge flow paths for filtered purified water by providing a plurality of spiral-wound membranes. That is, the membrane module, etc. provided in the above prior literature still has a structure in which raw water flows in and out of the membrane module in the longitudinal direction. Therefore, the membrane module, etc. provided in the above prior literature does not provide a method for ensuring the same filtration effect along the longitudinal direction.

Chinese Registered Utility Model Document No. 210855533 discloses a water purification system and water purifier. Specifically, it discloses a water purification system and water purifier that include a plurality of reverse osmosis sheets and have a structure in which raw water flowing therein can flow and be filtered through a plurality of flow paths.

However, the water purification system and water purifier disclosed in the above prior literature also merely presents a method for forming a plurality of discharge flow paths for filtered purified water. That is, the water purification system and water purifier provided in the above prior literature also does not provide a method for ensuring the same filtration effect along the longitudinal direction.

Chinese Registered Utility Model Document No. 210729181 discloses a reverse osmosis filtration device, reverse osmosis filter, and water purification system. Specifically, it discloses a reverse osmosis filtration device, reverse osmosis filter, and water purification system structured to include a single reverse osmosis sheet and an outlet for forming a discharge flow path for purified water filtered by the reverse osmosis sheet.

However, the reverse osmosis filtration device, etc. disclosed in the above prior literature also merely presents a method for forming a plurality of discharge flow paths for filtered purified water. That is, the reverse osmosis filtration device, etc. provided in the above prior literature also does not present a method for ensuring the same filtration effect along the longitudinal direction.
Chinese Patent Laid-open Publication No. 111185097 (2020.05.22.)
Chinese Registered Utility Model Document No. 210855533 (2020.06.26.)
Chinese Registered Utility Model Document No. 210729181 (2020.06.12.)

### SUMMARY OF THE INVENTION

### Technical Problem

The present invention is directed to providing a filter member having a structure capable of solving the above problems and a filter structure including the same.

First, the present invention is directed to providing a filter member having a structure capable of diversifying the direction in which fluid flows and a filter structure including the same.

In addition, the present invention is also directed to providing a filter member having a structure through which fluid can flow smoothly and a filter structure including the same.

In addition, the present invention is also directed to providing a filter member having a structure capable of delaying the occurrence of clogging caused by foreign substances generated during filtration of raw water, and a filter structure including the same.

In addition, the present invention is also directed to providing a filter member having a structure capable of filtering raw water multiple times and a filter structure including the same.

In addition, the present invention is also directed to providing a filter member having a structure that allows fluid introduced therein to flow throughout the entire space and a filter structure including the same.

### Technical Solution

In order to achieve the above objects, the present invention provides a filter member, including: a cylinder part extending in one direction; a filter hollow part which is formed inside the cylinder part to pass through along the one direction and allows the inside of the cylinder part to be in communication along the one direction; and a filtering part disposed to surround the cylinder part from radially outside and configured to filter raw water flowing through the filter hollow part, wherein the filtering part includes: a main filtering part which has one end coupled to the outer circumferential surface of the cylinder part and extends from the one end toward the other end and which is wound at least one time along the outer circumferential surface of the cylinder part to surround the outer circumferential surface of the cylinder part; and a sub-filtering part which has one end coupled to the other end of the main filtering part and extends from the one end toward the other end and which is wound along the outer circumference of the main filtering part to surround the outer circumference of the main filtering part, the sub-filtering part including a plurality of openings forming passages which the raw water passes through to enter the main filtering part.

In addition, a filter member may be provided in which the sub-filtering part of the filter member includes a plurality of ribs surrounding the plurality of openings.

In addition, a filter member may be provided in which among the plurality of ribs, adjacent ribs are spaced apart from each other and extend in parallel.

In addition, a filter member may be provided in which a portion of the plurality of ribs extend along the one direction in which the cylinder part extends, the other portion of the plurality of ribs extend along the outer circumferential direction of the cylinder part, and among the plurality of ribs, the portion and the other portion are formed to intersect each other at a predetermined angle.

In addition, a filter member may be provided in which the sub-filtering part includes a first sub-end coupled to the other end of the main filtering part; and a second sub-end continuous with the first sub-end and located radially outside the first sub-end, and the sub-filtering part is wound around the main filtering part so that the first sub-end and the second sub-end are coupled.

In addition, a filter member may be provided in which the length of the sub-filtering part in the outer circumferential direction is formed to be less than or equal to the length of the main filtering part in the outer circumferential direction, the sub-filtering part is formed of a material with a predetermined elongation rate, and the sub-filtering part presses the main filtering part radially inward and is wound around the main filtering part.

In addition, a filter member may be provided in which the plurality of openings are formed to have a diameter smaller than the diameter of any foreign substances mixed in the raw water, and when the raw water passes through the sub-filtering part, any foreign substances stay radially outside the sub-filtering part.

In addition, a filter member may be provided in which a plurality of the main filtering parts are provided, and the plurality of main filtering parts are spaced apart from each other along the outer circumferential direction of the cylinder part at a predetermined angle, and the sub-filtering part is coupled to the other end of any one of the plurality of main filtering parts.

In addition, a filter member may be provided in which among the plurality of main filtering parts, an angle between a pair of main filtering parts adjacent to each other is the same as an angle between another pair of adjacent main filtering parts adjacent to each other.

In addition, a filter member may be provided in which the plurality of main filtering parts are spaced apart along the outer circumferential direction of the cylinder part while forming the same angle as each other.

In addition, a filter member may be provided in which the main filtering part is provided in single pieces and is wound around the cylinder part at least once to surround the outer circumferential surface of the cylinder part, and the sub-filtering part extends from the other end of the main filtering part and is wound around the cylinder part to surround the outer circumference of the single main filtering part.

In addition, a filter member may be provided in which the raw water is introduced into the main filtering part along the one direction in which the cylinder part extends and the radial direction of the cylinder part, flows toward the filter hollow part, and is filtered.

In addition, the present invention provides a filter structure, including a housing having an accommodation space formed therein that communicates with the outside; a filter member accommodated in the accommodation space of the housing and configured to filter raw water delivered from the outside to produce purified water or living water; and a conduit unit extending in one direction and communicating the accommodation space and the filter member accommodated in the accommodation space with the outside, wherein the filter member include a cylinder part extending in the one direction; a filter hollow part formed through the inside of the cylinder part along the one direction, a portion of which communicates with the conduit unit and the accommodation space; and a filtering part disposed to surround the cylinder part from radially outside and configured to filter raw water flowing through the filter hollow part, wherein the conduit unit include an inlet conduit extending through the portion of the filter hollow part and communicating with the accommodation space; and an outlet conduit accommodated in the remaining portion of the filter hollow part, and communicating with the filter part, but being blocked from communication with the accommodation space and the inlet conduit, wherein the filtering part includes a main filtering part arranged to surround the outer circumferential surface of the cylinder part; and a sub-filtering part arranged to surround the outer circumferential surface of the main filtering part and having a plurality of openings formed therethrough in communication with the accommodation space, and wherein the raw water delivered to the accommodation space sequentially passes through the sub-filtering part and the main filtering part and flows toward the outlet conduit.

In addition, a filter structure may be provided in which the main filtering part has one end coupled to the outer circumferential surface of the cylinder part and is wound around the cylinder part, and the sub-filtering part is coupled to the other end of the main filtering part and is arranged to wind the main filtering part wound around the cylinder part.

In addition, a filter structure may be provided in which a portion of the raw water delivered to the accommodation space is introduced into the main filtering part through one end surface of the main filtering part along the one direction, and the remaining portion of the raw water delivered to the accommodation space passes through the sub-filtering part from the radial outside of the sub-filtering part and is introduced into the main filtering part.

In addition, a filter structure may be provided in which a plurality of the main filtering parts are provided, and the plurality of main filtering parts are spaced apart from each other at a predetermined angle in the outer circumferential direction of the cylinder part, and the sub-filtering part is coupled to one or more of the plurality of main filtering parts.

### Advantageous Effects

According to an exemplary embodiment of the present invention, the following effects can be achieved.

First, the filtering part includes a main filtering part and a sub-filtering part. The main filtering part is wound around the cylinder part forming the body of the filter member. The sub-filtering part is wound around the cylinder part while covering the main filtering part.

A plurality of openings are formed in the sub-filtering part. The plurality of openings communicate the radially outer space of the filter member with the interior of the main filtering part. Accordingly, raw water flowing in the outer space may pass through the sub-filtering part and flow into the main filtering part. At the same time, raw water can also be introduced through one end in a direction in which the main filtering part extends.

Accordingly, the flow path of raw water introduced into the filter member can extend in various directions.

In addition, as the flow path through which raw water enters the interior of the filter member extends in various directions, the degree of distribution of foreign substances separated from raw water can be reduced. That is, foreign substances separated from raw water are mainly accumulated in a location adjacent to the other end of the main filtering part due to the hydraulic pressure, etc. of raw water with an increased flow rate.

Therefore, the amount of foreign substances remaining on the path for the raw water flow to enter the filter hollow part communicating with the outside is reduced. As a result, raw water and purified water generated by filtering raw water can flow smoothly into the filter hollow part.

In addition, through the above-described configuration, the raw water introduced into the main filtering part can be filtered and flow smoothly into the filter hollow part. Foreign substances generated during the filtration process accumulate away from the path toward the filter hollow part.

Therefore, the time it takes for the generated foreign substances to accumulate in the path toward the filter hollow part increases. Accordingly, the time when clogging of the filter member occurs and the time when replacement of the filter member is required can be delayed, and thus the filter member can be used for a longer period of time.

In addition, the opening formed in the sub-filtering part is formed to have a very small cross-sectional area. Among foreign substances mixed in raw water, foreign substances with a cross-sectional area larger than the opening can be filtered by the sub-filtering part. In other words, the sub-filtering part can function as a filter that primarily filters raw water introduced into the main filtering part.

Therefore, compared to the case where the filtration process is performed only by the main filtering part, raw water can be produced as purified water through an additional filtration process.

In addition, due to the above configuration, raw water can flow into the main filtering part through various paths. Foreign substances formed when raw water is filtered accumulate adjacent to the end of the main filtering part, reducing the degree of distribution within the main filtering part.

Therefore, the raw water introduced into the main filtering part can flow and be filtered throughout the main filtering part. Accordingly, the filtration effect by the main filtering part can be improved.

### BRIEF DESCRIPTION OF THE DRAWINGS

FIG. 1 is a block diagram showing components of a water purifier according to an exemplary embodiment of the present invention.

FIG. 2 is a cross-sectional view showing a filter structure provided in the water purifier of FIG. 1.

FIG. 3 is a conceptual diagram showing the main filtering part of the filter structure of FIG. 2 in an unfolded state.

FIG. 4 is a conceptual diagram showing the main filtering part of the filter structure of FIG. 2 in a folded state.

FIG. 5 is a conceptual diagram showing both the main filtering part and the sub-filtering part provided in the filter structure of FIG. 2 in an unfolded state.

FIG. 6 is a plan view showing a process in which the main filtering part and the sub-filtering part provided in the filter structure of FIG. 2 are wound around the cylinder part.

FIG. 7 is a conceptual diagram showing the direction in which raw water flows into the filter structure of FIG. 1.

FIG. 8 is a conceptual diagram showing the flow of fluid in the filter structure of FIG. 1.

FIG. 9 is a conceptual diagram showing a filter structure provided in the water purifier of FIG. 1 according to another embodiment.

FIG. 10 is a conceptual diagram showing the direction in which raw water flows into the filter structure of FIG. 8.

FIG. 11 is a conceptual diagram showing the flow of fluid in the filter structure of FIG. 8.

FIG. 12 is a conceptual diagram showing a change (a) in the concentration of foreign substances accumulated inside a filter structure according to an exemplary embodiment of the present invention and the resulting fluid flow (b).

FIG. 13 is a conceptual diagram showing a filter structure according to the related art.

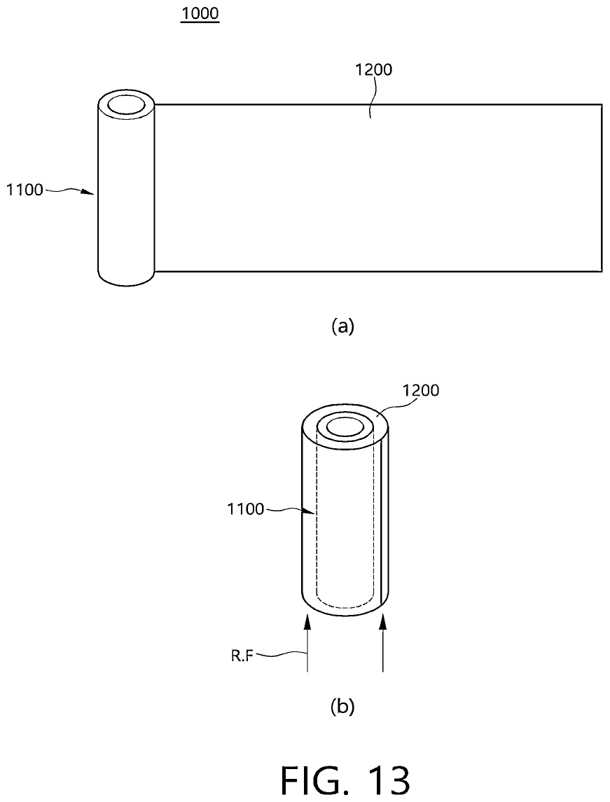

FIG. 14 is a conceptual diagram showing the raw water flow in a filter structure according to the related art.

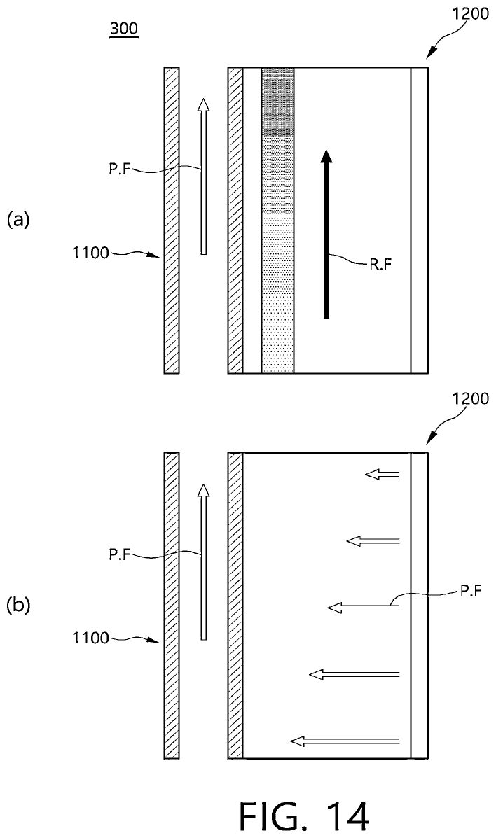

### DETAILED DESCRIPTION OF THE EMBODIMENTS

Hereinafter, a filter structure 10, 20 for purification and a water purifier 1 including the same according to an exemplary embodiment of the present invention will be described in detail with reference to the accompanying drawings.

In the following description, in order to clarify the features of the present invention, descriptions of some components may be omitted.

The term “communication” used in the following description means that one or more members are connected to each other so as to be in fluid communication. In an embodiment, communication may be formed by a member such as a conduit, a pipe, a tubing, or the like.

The term “energization” used in the following description means that one or more members are connected to each other so as to transmit an electric current or an electric signal. In an embodiment, the energization may be formed in a wired form by a wire member or the like or in a wireless form such as Bluetooth, Wi-Fi, RFID, or the like.

The term “raw water” used in the following description refers to any fluid supplied without going through a filtration process for the user to drink or use as water for life. In an embodiment, the raw water may be tap water.

The term “filtration or filtering” used in the following description refers to any treatment process applied to raw water to be used as water for the user to drink or live. In an embodiment, filtration may include a process for removing foreign substances or any substances in the raw water in a physical, chemical, or electrical manner.

The term “purified water” used in the following description refers to any fluid that a user can drink among fluids generated by filtering raw water.

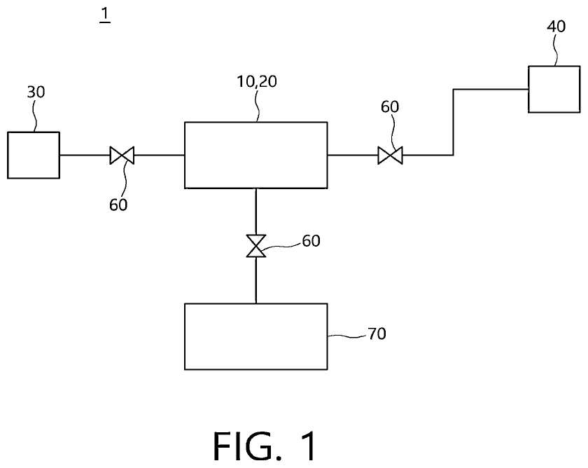

Referring to FIG. 1, a configuration of a water purifier 1 according to an exemplary embodiment of the present invention is illustrated.

The water purifier 1 may receive raw water from the outside. To this end, the water purifier 1 communicates with an external raw water supply source (not shown). The above raw water supply source (not shown) may be configured to communicate with a raw water supply unit 30 to transmit raw water to the raw water supply unit 30 apart from the raw water supply unit 30 shown in FIG. 1.

In the illustrated embodiment, the water purifier 1 includes a filter structure 10, 20, a raw water supply unit 30, a purified water discharge unit 40, a valve unit 60, and a control unit 70. In the above configuration, the filter structure 10, 20, the raw water supply unit 30, and the purified water discharge unit 40 may be in communication with each other. The communication can be achieved by the valve unit 60 and the control unit 70 that communicates with or is energized with the valve unit 60.

The operation of the valve unit 60 is controlled by the control unit 70, and the process by which each component of the water purifier 1 communicates with or blocks each other is a well-known technology, so detailed description thereof will be omitted.

The filter structure 10, 20 receives and accommodates raw water from the raw water supply unit 30, filter it as purified water or living water, and discharge it to the outside. To this end, the filter structure 10, 20 communicates with the raw water supply unit 30, the purified water discharge unit 40, and a living water discharge unit (not shown).

In particular, the filter structure 10, 20 according to an exemplary embodiment of the present invention allows raw water to flow into a member provided for filtration through various flow paths. Accordingly, the amount of foreign substances filtered from raw water remaining inside the member of the filter structure 10, 20 can be minimized. This will be described later in detail.

The raw water supply unit 30 receives raw water from an external raw water supply source (not shown). The received raw water is delivered to the filter structure 10, 20, filtered into purified water or living water, and then delivered to the user.

In the illustrated embodiment, the raw water supply unit 30 is shown as being included as a component of the water purifier 1. Alternatively, it will be understood that if the water purifier 1 is provided as a direct water type, the raw water supply unit 30 may be replaced with an external water pipe or the like.

The purified water discharge unit 40 discharges purified water formed by filtering raw water to the outside. The user can discharge purified water by manipulating the purified water discharge unit 40 or the control unit 70 configured to control the purified water discharge unit 40.

The purified water discharge unit 40 communicates with the filter structure 10, 20.

The valve unit 60 allows or blocks communication between each component of the water purifier 1. The valve unit 60 is provided between the components communicating with each other among the components of the water purifier 1, that is, between the filter structure 10, 20, the raw water supply unit 30, and the purified water discharge unit 40, respectively, in the illustrated embodiment.

The valve unit 60 may allow or block communication between the components. The above process may be automatically performed by the control unit 70 or may be achieved through user manipulation.

The valve unit 60 may be provided in any form that allows or blocks communication between two or more members in communication with each other. In an embodiment, the valve unit 60 may be configured to be operated by an electrical signal or physical manipulation.

The control unit 70 automatically or manually controls the operation of the valve unit 60. The control unit 70 is energizably connected to the valve unit 60.

In an embodiment in which the control unit 70 manually controls the operation of the valve unit 60, the control unit 70 may include an input module (not shown) to be operated by a user. The user may apply a control signal to control the valve unit 60 by physically manipulating the input module (not shown) or by applying an electrical signal to the input module (not shown).

Since the process of controlling the valve unit 60 by the control unit 70 is a well-known technology, detailed description thereof will be omitted.

### 3. Description of the Configuration of the Filter Structure 10, 20 According to an Exemplary Embodiment of the Present Invention

The filter structure 10, 20 according to an exemplary embodiment of the present invention allows the introduced raw water to flow into a filter member 300 through various paths. Therefore, compared to the case where raw water flows into the filter member 300 in only one direction, foreign substances may be spread out and distributed over a wider space. Accordingly, the concentration of foreign substances in a specific space may decrease.

Therefore, the occurrence of the TDS creep phenomenon, which may occur when the concentration of foreign substances is excessively increased, can be suppressed. In addition, since large amounts of foreign substances do not remain in a specific space, purified water and fluid for cleaning can flow more easily. As a result, the flow of raw water and purified water proceeds smoothly, and the same filtration effect can be guaranteed throughout the filter member 300.

The filter structure 10, 20 communicates with the outside. The filter structure 10, 20 may receive raw water from an external raw water supply unit 30 and filter it. The filter structure 10, 20 may deliver filtered purified water to the purified water discharge unit 40.

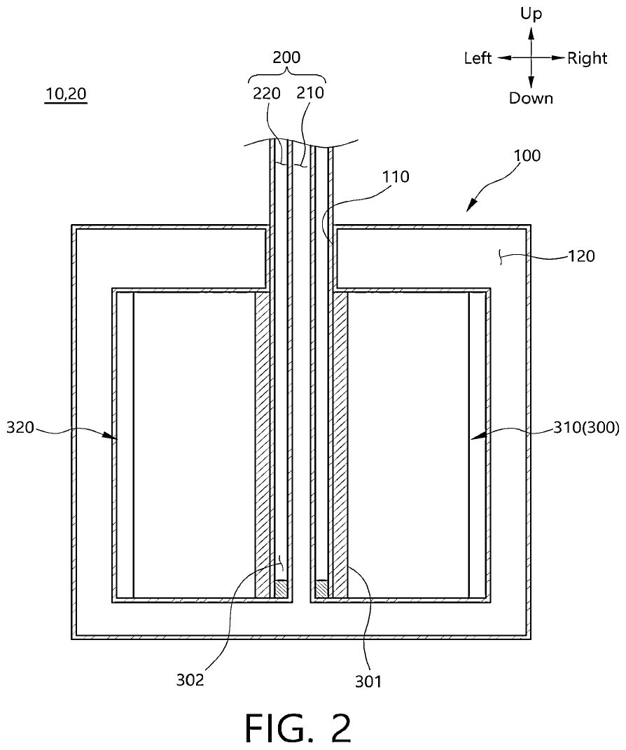

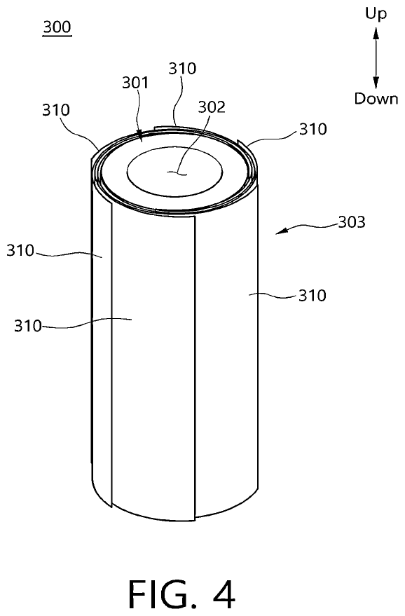

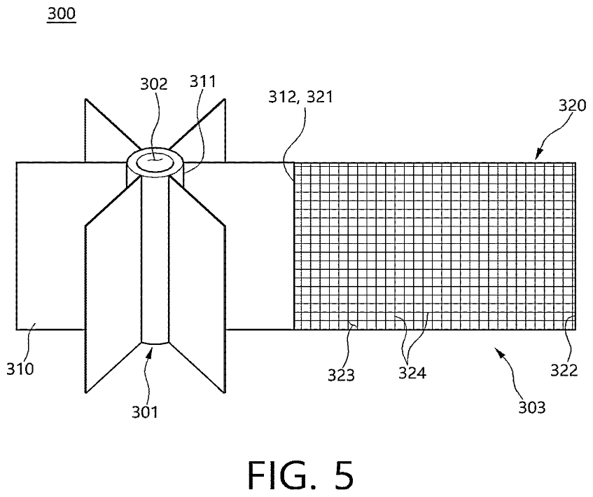

Hereinafter, the filter structure 10, 20 according to an exemplary embodiment of the present invention will be described in detail with reference to FIGS. 2 to 7.

Referring to FIGS. 2 to 6, a filter structure 10 according to an exemplary embodiment of the present invention is shown.

In the illustrated embodiment, the filter structure 10 includes a housing 100, a conduit unit 200, and a filter member 300.

The housing 100 forms the outer shape of the filter structure 10. A space communicating with the outside is formed inside the housing 100. Other components constituting the filter structure 10, such as the conduit unit 200 and the filter member 300 in the illustrated embodiment, may be accommodated in the space. In this case, the conduit unit 200 penetrates the housing 100, and a portion of it is located on the outside of the housing 100, and the remaining portion is located on the inside of the housing 100.

Raw water may be introduced into the space of the housing 100. In addition, purified water or living water may be discharged from the space of the housing 100.

The housing 100 may have any shape that accommodates the components of the filter structure 10 and communicates with the outside to allow the inflow and outflow of raw water, purified water, or living water. In the illustrated embodiment, the housing 100 has a cylindrical shape extending elongated in the up-down direction.

In the illustrated embodiment, the housing 100 includes a housing opening 110, an accommodation space 120, and a blocking member 130.

The housing opening 110 communicates the space of the housing 100 with the outside. The housing opening 110 is formed through the outer circumferential surface surrounding the space of the housing 100. The conduit unit 200 may pass through the housing opening 110.

The housing opening 110 may be formed at any position that allows communication between the space of the housing 100 and the outside. In the illustrated embodiment, the housing opening 110 is formed on the upper outer circumferential surface of the housing 100.

In the illustrated embodiment, a single housing opening 110 is formed. A plurality of conduit units 200 pass through a single housing opening 110. Alternatively, a plurality of housing openings 110 may be formed to allow a plurality of conduit units 200 to pass through, respectively.

The accommodation space 120 is a space formed inside the housing 100.

That is, the space of the housing 100 may be defined as the accommodation space 120.

The accommodation space 120 communicates with the outside. The accommodation space 120 communicates with the raw water supply unit 30 and the purified water discharge unit 40 through the housing opening 110 and the conduit unit 200 passing therethrough.

The accommodation space 120 is defined by being surrounded by the outer circumferential surface of the housing 100. The accommodation space 120 may communicate with the outside only through the housing opening 110.

A portion of the conduit unit 200 and the filter member 300 are accommodated in the accommodation space 120.

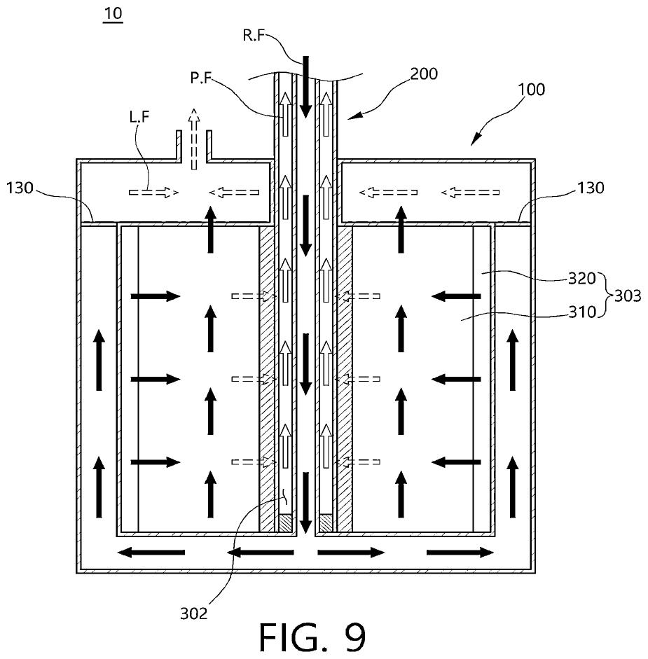

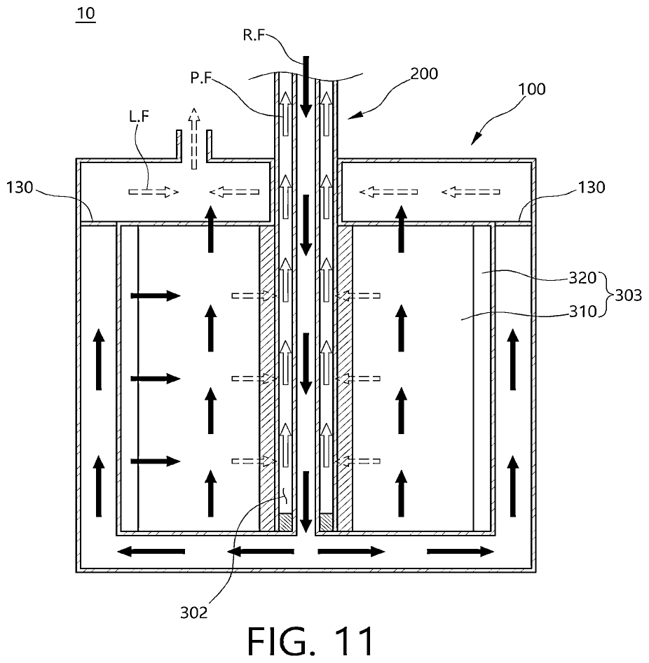

With further reference to FIGS. 9 and 11, the housing 100 further includes a blocking member 130.

The blocking member 130 controls the raw water flow (R.F) introduced into the accommodation space 120. Due to the blocking member 130, raw water introduced into the accommodation space 120 must pass through the filter member 300 before being discharged to the outside again.

The blocking member 130 is coupled to the filter member 300. Specifically, the blocking member 130 is coupled to one end of the radially outer side of the filter member 300 and the housing 100 surrounding the radially outer side, respectively.

In the illustrated embodiment, the blocking member 130 extends horizontally from the upper end of the filter member 300 and is coupled to the housing 100. Accordingly, the introduced raw water may flow to a height where the upper end of the filter member 300 is located and then enter the interior of the filter member 300.

A plurality of blocking members 130 may be provided. The plurality of blocking members 130 may be located in different places and respectively control the raw water flow (R.F). In the illustrated embodiment, two blocking members 130 are provided, each extending radially outward from the left upper end and the right upper end of the filter member 300 and coupled to the housing 100, respectively.

In the illustrated embodiment, the blocking member 130 located on the left side may control the raw water flow (R.F) flowing between the left portion of the housing 100 and the filter member 300. In addition, the blocking member 130 located on the right side may control the raw water flow (R.F) flowing between the right portion of the housing 100 and the filter member 300.

The conduit unit 200 is coupled to the housing 100 and communicates the accommodation space 120 with the outside. The conduit unit 200 extends from the accommodation space 120 of the housing 100 to the outside of the housing 100.

A plurality of conduit units 200 may be provided. The plurality of conduit units 200 may communicate the accommodation space 120 with different external components. The illustrated embodiment provides two conduit units 200, including an inlet conduit 210 and an outlet conduit 220.

The inlet conduit 210 communicates the accommodation space 120 with the raw water supply unit 30. The outlet conduit 220 communicates the accommodation space 120 with the purified water discharge unit 40.

Although not shown, a plurality of outlet conduits 220 may be provided. One or more of the plurality of outlet conduits 220 may communicate with the purified water discharge unit 40, and the other one or more may communicate with the living water discharge unit (not shown). In the above embodiment, a housing opening 110 for communication with the living water discharge unit (not shown) may be additionally formed.

The inlet conduit 210 and the outlet conduit 220 may be arranged in various shapes. In the embodiment shown in FIG. 2, the inlet conduit 210 is accommodated inside the outlet conduit 220 formed to have a larger diameter cross-section. In the above embodiment, the filter structure 10 may be rotated and coupled to the water purifier 1 or removed from the water purifier 1.

Alternatively, the inlet conduit 210 and the outlet conduit 220 may be arranged to be spaced apart from each other. In the above embodiment, a plurality of housing openings 110 may be formed to be spaced apart from each other to correspond to the arrangement method of the inlet conduit 210 and the outlet conduit 220.

The inlet conduit 210 is formed to extend in the extension direction of the housing 100, that is, in the up-down direction in the illustrated embodiment. One end in the extension direction of the inlet conduit 210, that is, the lower end in the illustrated embodiment, is located in the accommodation space 120. The other end in the extension direction of the inlet conduit 210, i.e., the upper end in the illustrated embodiment, is located outside the housing 100 and communicates with the raw water supply unit 30.

The inlet conduit 210 may penetrate the inside of the filter member 300. That is, as will be described later, inside the filter member 300, a hollow extending in the longitudinal direction thereof is formed. The inlet conduit 210 may penetrate the hollow and extend to the lower side of the filter member 300.

Accordingly, raw water may pass through the filter member 300 through the inlet conduit 210 and then flow into the accommodation space 120.

The inlet conduit 210 is accommodated inside the outlet conduit 220.

The outlet conduit 220 extends in the extension direction of the housing 100, i.e., in the up-down direction in the illustrated embodiment. It will be understood that the extension direction of the outlet conduit 220 is the same as the extension direction of the inlet conduit 210.

One end in the extension direction of the outlet conduit 220, i.e., the lower end in the illustrated embodiment, communicates with a filter hollow part 302 of the filter member 300. The other end in the extension direction of the outlet conduit 220, i.e., the upper end in the illustrated embodiment, is located outside the housing 100 and communicates with the purified water discharge unit 40.

The outlet conduit 220 may communicate with the upper end of the filter member 300. In an embodiment, the lower end of the outlet conduit 220 may be partially accommodated in the filter hollow part 302.

Accordingly, the purified water filtered by the filter member 300 flows along the filter hollow part 302 and the outlet conduit 220 and may be discharged into the purified water discharge unit 40.

The filter member 300 filters raw water introduced from the raw water supply unit 30 to generate purified water. The filter member 300 is accommodated in the accommodation space 120 of the housing 100.

The filter member 300 communicates with the accommodation space 120. Raw water in the accommodation space 120 may flow into the filter member 300.

The filter member 300 communicates with the purified water discharge unit 40 through the outlet conduit 220. The purified water generated by the filter member 300 may be discharged to the outside through the outlet conduit 220.

The filter member 300 may be provided in an arbitrary form capable of generating purified water by filtering introduced raw water. In an embodiment, the filter member 300 may be provided in the form of a reverse osmosis filter including a membrane.

In the illustrated embodiment, the filter member 300 includes a cylinder part 301, a filter hollow part 302, and a filtering part 303.

The cylinder part 301 forms the body of the filter member 300. The cylinder part 301 is formed extending in the longitudinal direction, i.e., in the up-down direction in the illustrated embodiment. It will be understood that the extension direction of the cylinder part 301 is the same as the extension direction of the housing 100.

Although not shown, the cylinder part 301 may be coupled to the housing 100 by any member. The member may be coupled to each end in the extension direction of the cylinder part 301, i.e., to the upper end and the lower end in the illustrated embodiment, respectively.

The cylinder part 301 forms the body of the filter member 300 and may be of any shape capable of supporting other components of the filter member 300. In the illustrated embodiment, the cylinder part 301 has a cylindrical shape having a circular cross-section and extending in the up-down direction.

A hollow is formed through the inside of the cylinder part 301 along its longitudinal direction. The hollow may be named filter hollow part 302.

The filter hollow part 302 forms a space that accommodates the inlet conduit 210. In addition, the filter hollow part 302 forms a flow path through which filtered purified water flows toward the outlet conduit 220.

The filter hollow part 302 is formed through the inside of the cylinder part 301. The filter hollow part 302 extends in the same direction as the cylinder part 301, and each end in the extension direction is formed open so that it can communicate with the outside.

In the illustrated embodiment, the upper end of the filter hollow part 302 communicates with the outlet conduit 220. In addition, the lower end of the filter hollow part 302 is closed and physically spaced apart from the accommodation space 120.

The conduit unit 200 is accommodated in the filter hollow part 302. The inlet conduit 210 may penetrate the filter hollow part 302 and its lower end may communicate with the accommodation space 120. The outlet conduit 220 accommodates the inlet conduit 210 therein and is coupled to the filter hollow part 302, with its lower end located in the filter hollow part 302. That is, the outlet conduit 220 is partially inserted into the filter hollow part 302.

The filter hollow part 302 may be formed in any shape that can accommodate the conduit unit 200. In the illustrated embodiment, the filter hollow part 302 has a cylindrical shape having a circular cross-section and extending in the up-down direction. In this case, the cross-sectional diameter of the filter hollow part 302 may be formed to be larger than or equal to the cross-sectional diameters of the inlet conduit 210 and the outlet conduit 220.

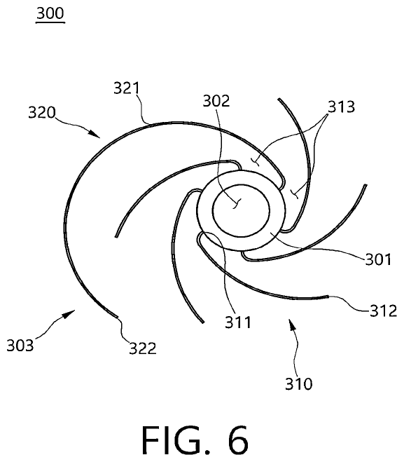

The filtering part 303 filters the raw water supplied into the housing 100 to generate purified water. The filtering part 303 is coupled to the cylinder part 301. Specifically, one end of the filtering part 303 in its extension direction may be coupled to the cylinder part 301. The filtering part 303 may be formed to surround the outer circumferential surface of the cylinder part 301 (see FIG. 6).

In the illustrated embodiment, the filtering part 303 includes a main filtering part 310 and a sub-filtering part 320.

The main filtering part 310 filters foreign substances mixed in the introduced raw water and generates purified water. The main filtering part 310 is coupled to the outer circumferential surface of the cylinder part 301.

In an embodiment in which the filter member 300 is provided as a reverse osmosis filter, the main filtering part 310 may be provided as a membrane for forming a reverse osmosis filter. In the above embodiment, the main filtering part 310 may be formed of a flexible material and be deformed in shape. The main filtering part 310 may be wound around the cylinder part 301 and formed to surround the outer circumferential surface of the cylinder part 301.

The main filtering part 310 may extend in a direction away from the cylinder part 301, that is, radially outward. One end in a direction in which the main filtering part 310 extends, that is, an end in a direction toward the cylinder part 301, may be coupled to the cylinder part 301.

The other end in the direction in which the main filtering part 310 extends, that is, an end in a direction opposite to the cylinder part 301, may be in a free end state. The other end of the main filtering part 310 may be constrained by the sub-filtering part 320 to be described later.

In the illustrated embodiment, the main filtering part 310 is formed to have a quadrangular cross-section having a height in the direction in which the cylinder part 301 extends, that is, in the up-down direction, and a width in the radial direction of the cylinder part 301. The main filtering part 310 may have an arbitrary shape capable of generating purified water by filtering raw water.

A plurality of main filtering parts 310 may be provided. The plurality of main filtering parts 310 may be spaced apart from each other and may be coupled to the outer circumferential surface of the cylinder part 301, respectively. In the illustrated embodiment, six main filtering parts 310 are provided and are spaced apart from each other.

In this case, a plurality of main filtering parts 310 may be arranged to form a predetermined contained angle (a) with respect to the center of the cylinder part 301. In an embodiment, the contained angle (a) between the main filtering parts 310 adjacent to each other may be the same.

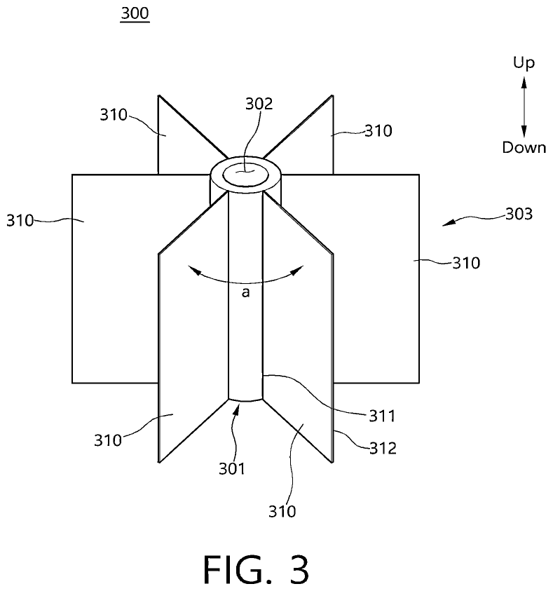

In the embodiment illustrated in FIG. 3, six main filtering parts 310 are provided and are spaced apart from each other to form a contained angle (a) of the same size. In the above embodiment, the contained angle (a) may be 60°.

In an embodiment in which a plurality of main filtering parts 310 are provided, the plurality of main filtering parts 310 may be arranged to surround the outer circumferential surface of the cylinder part 301 along either a clockwise or counterclockwise direction. In the embodiment shown in FIG. 6, the plurality of main filtering parts 310 are deformed in shape in a counterclockwise direction and are formed to surround the outer circumferential surface of the cylinder part 301.

In the above embodiment, any one main filtering part 310 of the adjacent main filtering parts 310 may be wound around the cylinder part 301 first, and the other main filtering part 310 may be wound around the cylinder part 301 while covering the any one main filtering part 310. In the embodiment shown in FIG. 6, the main filtering part 310 located on the downstream side along the clockwise direction covers the main filtering part 310 located on the relatively upstream side and is wound around the cylinder part 301.

Accordingly, in the above embodiment, a plurality of flow spaces 313 may be formed between the plurality of main filtering parts 310. The plurality of flow spaces 313 may communicate with the accommodation space 120 in a radial direction by the sub-filtering part 320. As a result, a plurality of raw water flows R.F may be formed along the radial direction, and a detailed description thereof will be described later.

In the illustrated embodiment, the main filtering part 310 includes a first main end 311, a second main end 312, and a flow space 313.

The first main end 311 forms one end in the width direction of the main filtering part 310, that is, in the radial direction of the cylinder part 301. In the illustrated embodiment, the first main end 311 is located relatively radially inward compared to the second main end 312.

The first main end 311 is coupled to the cylinder part 301. The main filtering part 310 may be wound around the cylinder part 301 along the clockwise or counterclockwise direction around the first main end 311.

The second main end 312 forms the other end in the width direction of the main filtering part 310, that is, in the radial direction of the cylinder part 301. In the illustrated embodiment, the second main end 312 is located relatively radially outward compared to the first main end 311.

The second main end 312 is coupled to the sub-filtering part 320. The sub-filtering part 320 may be wound around the cylinder part 301 along the clockwise or counterclockwise direction around the second main end 312 while covering the main filtering part 310. As will be described later, the direction in which the sub-filtering part 320 is wound around the cylinder part 301 may be the same as the direction in which the main filtering part 310 is wound around the cylinder part 301.

The flow space 313 may be defined as a space formed between the plurality of main filtering parts 310 wound and stacked around the cylinder part 301. Raw water is introduced into the flow space 313. The introduced raw water flows radially inward along the flow space 313 and may flow toward the filter hollow part 302. The flow space 313 communicates with the filter hollow part 302.

A plurality of flow spaces 313 may be formed. That is, in an embodiment in which a plurality of main filtering parts 310 are provided, the flow space 313 may be formed between main filtering parts 310 that are adjacent to each other, respectively.

In particular, the filter structure 10 according to an exemplary embodiment of the present invention may have various paths through which raw water enters the flow space 313. For example, raw water may enter the flow space 313 along the longitudinal direction of the cylinder part 301, that is, in the up-down direction. In addition, raw water may enter the flow space 313 along the radial direction of the cylinder part 301, that is, the radial direction of the wound main filtering part 310. This will be described later in detail.

The sub-filtering part 320 primarily filters the introduced raw water before the raw water is introduced into the main filtering part 310. In addition, the sub-filtering part 320 communicates the flow space 313 of the main filtering part 310 with the accommodation space 120 to form an additional flow path for raw water. The sub-filtering part 320 is coupled to the main filtering part 310.

In an embodiment in which the filter member 300 is provided as a reverse osmosis filter, the sub-filtering part 320 may surround the main filtering part 310 from radially outside and may be wound around the cylinder part 301. In the above embodiment, the sub-filtering part 320 may be formed of a flexible material and be deformed in shape.

The sub-filtering part 320 may be formed to have a predetermined elasticity. In other words, the sub-filtering part 320 may be formed of a material having a predetermined elongation rate.

In the above embodiment, the sub-filtering part 320 may be formed to extend shorter than the length of the outer circumference of the cylinder part 301. Accordingly, the sub-filtering part 320 may be wound around the cylinder part 301 in a state extended in its width direction by an external force.

In the above embodiment, the sub-filtering part 320 may be wound around the cylinder part 301 while pressing the main filtering part 310 located radially inside the sub-filtering part 310 radially inward. Accordingly, the main filtering part 310 is wound in close contact with the outer circumferential surface of the cylinder part 301.

As a result, the size of the flow space 313 formed between the plurality of main filtering parts 310 is reduced, and the filtration effect of raw water flowing into the flow space 313 can be improved.

The sub-filtering part 320 may extend in a direction away from the cylinder part 301, that is, radially outward in the illustrated embodiment. One end in a direction in which the sub-filtering part 320 extends, that is, an end in a direction toward the cylinder part 301, may be coupled to the main filtering part 310. It will be understood that the one end may be defined as one end facing the main filtering part 310.

The other end in a direction in which the sub-filtering part 320 extends, that is, an end in a direction opposite to the cylinder part 301 or the main filtering part 310, may be in a free end state. The other end of the sub-filtering part 320 may be coupled to the one end.

In the illustrated embodiment, the sub-filtering part 320 is formed to have a quadrangular cross-section having a height in the direction in which the cylinder part 301 extends, that is, in the up-down direction, and a width in the same direction as the width of the main filtering part 310. That is, the sub-filtering part 320 is formed in a shape similar to that of the main filtering part 310. The sub-filtering part 320 may have an any shape capable of surrounding the main filtering part 310 from radially outside and primarily filtering the introduced raw water.

In an embodiment in which a plurality of main filtering parts 310 are provided, the sub-filtering part 320 may be coupled to any one main filtering part 310 of the plurality of main filtering parts 310. The sub-filtering part 320 may be coupled to the second main end 312 of the any one main filtering part 310.

The sub-filtering part 320 may be arranged to surround the outer circumferential surface of the cylinder part 301 along either a clockwise direction or a counterclockwise direction. In the embodiment shown in FIG. 6, the sub-filtering part 320 is formed to be deformed in a counterclockwise direction to surround the outer circumferential surface of the cylinder part 301 and a plurality of main filtering parts 310 wound thereon.

In the above embodiment, the sub-filtering part 320 may be wound around the cylinder part 301 while covering the main filtering part 310 located on the downstream side in the clockwise direction compared to the coupled main filtering part 310.

That is, the sub-filtering part 320 is wound around the cylinder part 301 so that a plurality of main filtering parts 310 and sub-filtering parts 320 are sequentially stacked in a direction toward the radial outer side of the cylinder part 301.

In the illustrated embodiment, the sub-filtering part 320 includes a first sub-end 321, a second sub-end 322, an opening 323 and a rib 324.

The first sub-end 321 forms one end in the width direction of the sub-filtering part 320, that is, in the radial direction of the cylinder part 301.

It will be understood that the direction is the same as the width direction of the main filtering part 310. In the illustrated embodiment, the first sub-end 321 is located relatively radially inward compared to the second sub-end 322.

The first sub-end 321 is coupled to the main filtering part 310.

Specifically, the first sub-end 321 is coupled to the second main end 312 located radially outward. The sub-filtering part 320 may be wound around the cylinder part 301 along the clockwise or counterclockwise direction around the first sub-end 321 while covering the main filtering part 310.

In this case, the sub-filtering part 320 may be wound around the cylinder part 301 in the same direction as the main filtering part 310 is wound.

The second sub-end 322 forms the other end in the width direction of the sub-filtering part 320, that is, in the radial direction of the cylinder part 301. In the illustrated embodiment, the second sub-end 322 is located relatively radially outward compared to the first sub-end 321.

The second sub-end 322 may be coupled to the first sub-end 321. That is, after the sub-filtering part 320 is wound around the cylinder part 301 while covering the main filtering part 310, the second sub-end 322 may be coupled and fastened to the first sub-end 321. In this case, as described above, the sub-filtering part 320 may be in a state extended by an external force.

The opening 323 is formed through the sub-filtering part 320 and communicates the inside and the outside of the sub-filtering part 320.

Accordingly, the accommodation space 120 on the radial outer side of the sub-filtering part 320 and the main filtering part 310 on the radially inner side of the sub-filtering part 320 may be communicated.

The opening 323 may be formed to have a very small area. This is to allow only raw water from which mixed foreign substances have been filtered to enter the main filtering part 310. In an embodiment, the opening 323 may be formed to have an area larger than the foreign substance to be filtered by the main filtering part 310. In the above embodiment, the sub-filtering part 320 may pre-filter excessive foreign substances that are difficult for the main filtering part 310 to filter, thereby improving the filtration effect.

The opening 323 may be of any shape capable of communicating the accommodation space 120 and the main filtering part 310. In the illustrated embodiment, the opening 323 is formed to have a quadrangular cross-section.

A plurality of openings 323 may be formed. The plurality of openings 323 may be spaced apart from each other and arranged in various ways. In the illustrated embodiment, the plurality of openings 323 are arranged side by side along the height and width directions of the sub-filtering part 320, and are spaced apart from each other with ribs 324 formed between adjacent openings 323.

The ribs 324 are located between the openings 323 and partition the openings 323 adjacent to each other. In addition, the rib 324 extends in the height and width directions of the sub-filtering part 320 to form a body of the sub-filtering part 320.

A plurality of ribs 324 may be provided. The plurality of ribs 324 may extend in different directions to surround a plurality of openings 323. In the illustrated embodiment, a portion of the plurality of ribs 324 extend in the width direction of the sub-filtering part 320, and the remaining portion extends in the height direction, respectively.

The portion of the ribs 324 and the remaining portion of the ribs 324 may intersect each other at a predetermined angle. In an embodiment, the predetermined angle may be a right angle.

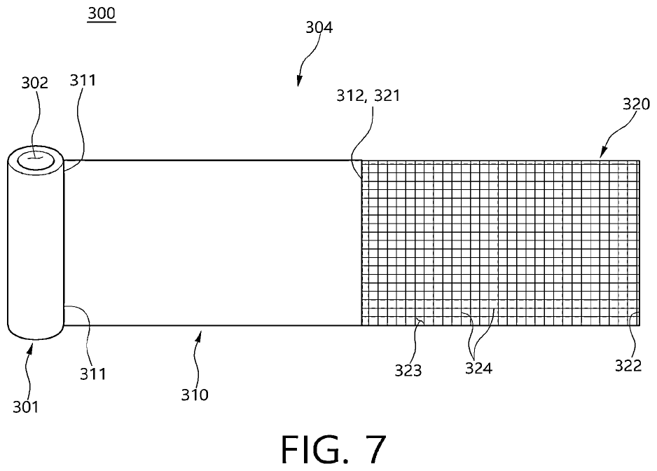

Referring to FIG. 7, a filter member 300 provided in a filter structure 20 according to another exemplary embodiment of the present invention is shown.

The filter structure 20 according to the present embodiment has the same structure and function as the filter structure 10 according to the above-described embodiment. However, the filter structure 20 according to the present embodiment has some differences from the filter structure 10 described above in the specific structure of the filter member 300, specifically the structure of the filtering part 304.

Accordingly, in the following description, the configuration of the filter structure 20 according to another exemplary embodiment of the present invention will be described focusing on the filter member 300.

The filter structure 20 according to the present embodiment includes a housing 100, a conduit unit 200, and a filter member 300. Among these, the housing 100 and the conduit unit 200 have the same structure and function as those of the filter structure 10 according to the above-described embodiment.

In the illustrated embodiment, the filter member 300 includes a cylinder part 301, a filter hollow part 302, and a filtering part 304.

The filter member 300 according to the present embodiment is different from the filter member 300 according to the above-described embodiment in the structure of the filtering part 304.

That is, in this embodiment, a single main filtering part 310 is provided and coupled to the outer circumference of the cylinder part 301. The single main filtering part 310 is wound around the cylinder part 301. Accordingly, a single flow space 313 is also formed, so that the raw water flow (R.F) in the radial direction may extend toward only the single flow space 313.

In this case, the main filtering part 310 is coupled to the outer circumference of the cylinder part 301 by the first main end 311. In addition, the sub-filtering part 312 is coupled to the second main end 320.

In addition, since the structure and coupling structure of the filtering part 304 are the same as those of the filtering part 303 in the above-described embodiment, the description thereof will be replaced with the above-described description.

The filter structure 10, 20 according to an exemplary embodiment of the present invention allows raw water to flow into the filter member 300 along various directions. Accordingly, the amount and filtration speed of raw water to be filtered can be increased, thereby improving filtration efficiency.

In addition, since raw water is filtered along various flow paths, the volume of space where foreign substances separated from raw water are distributed can be reduced. Furthermore, the possibility that the flow path in the direction toward the filter hollow part 302 is blocked by foreign substances is reduced, allowing smooth flow of raw water and purified water.

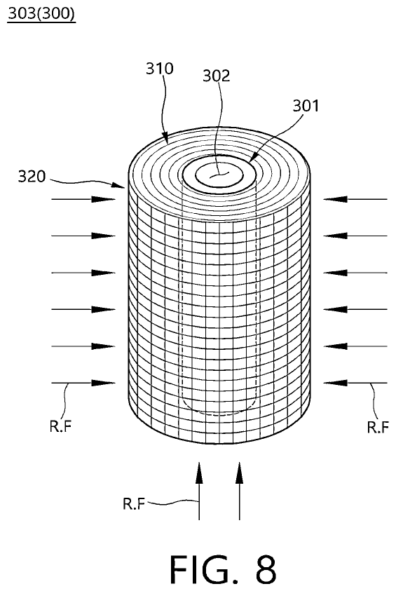

Hereinafter, a flow path formed inside the filter structure 10, 20 according to an exemplary embodiment of the present invention will be described in detail with reference to FIGS. 8 to 11.

Referring to FIGS. 8 to 9, a flow path formed inside the filter structure 10 according to an exemplary embodiment of the present invention is shown.

First, a raw water flow (R.F) may extend into the flow space 313 through one end in the height direction of the main filtering part 310 of the filter member 300, that is, the lower end in the illustrated embodiment.

In addition, a sub-filtering part 320 having a plurality of openings 323 is formed on the radial outer side of the filtering part 303. Accordingly, raw water that has advanced to the radially outer space of the filtering part 303 in the accommodation space 120 may pass through the outer circumference of the filtering part 303 and enter the flow space 313. Specifically, a raw water flow (R.F) passes through the sub-filtering part 320 in the radial outer space and extends into the flow space 313.

A portion of the raw water flowing along the raw water flow (R.F) flows toward the filter hollow part 302 and is filtered as purified water. The filtered purified water forms a purified water flow (P.F) extending along the filter hollow part 302 and the outlet conduit 220 and flows to the external purified water discharge unit 40.

The remaining portion of the raw water flowing along the raw water flow (R.F) proceeds to the accommodation space 120 through the other end in the height direction of the main filtering part 310, that is, the upper end in the illustrated embodiment. The fluid is not filtered enough for drinking, but is filtered compared to raw water.

Accordingly, the fluid may be named living water. A living water flow (L.F) may proceed to the external living water discharge unit (not shown) through an opening (reference numeral not indicated, upper side of FIG. 9) formed in the housing 100.

Therefore, the filter structure 10 according to the present embodiment allows raw water to pass through the sub-filtering part 320 as well as one end in the height direction of the filtering part 303, that is, the lower end in the illustrated embodiment and to flow into the flow space 313 in the radial direction as well.

Accordingly, a plurality of raw water flows (R.F) are formed so that the flow path of raw water can be diversified, and the flow efficiency of raw water can be improved. Furthermore, foreign substances separated from raw water also stay in various directions, so the concentration of foreign substances staying in any space can be reduced. As a result, the service life of the filter structure 10 and the cleanliness of the filtered purified water can be further improved.

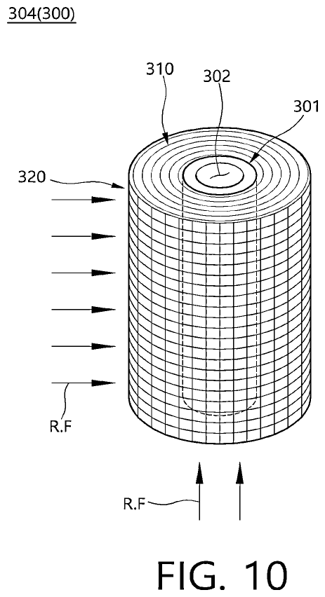

Referring to FIGS. 10 to 11, a flow path formed inside the filter structure 20 according to another exemplary embodiment of the present invention is shown.

First, a raw water flow (R.F) may extend into the flow space 313 through one end in the height direction of the main filtering part 310 of the filter member 300, that is, the lower end in the illustrated embodiment.

In addition, a sub-filtering part 320 having a plurality of openings 323 is formed on the radial outer side of the filtering part 303. Accordingly, raw water that has advanced to the radially outer space of the filtering part 303 in the accommodation space 120 may pass through the outer circumference of the filtering part 303 and enter the flow space 313. Specifically, a raw water flow (R.F) passes through the sub-filtering part 320 in the radial outer space and extends into the flow space 313.

In this case, unlike the filter structure 10 according to the above-described embodiment, the filtering part 304 of the filter structure 10 according to the present embodiment is provided with a single main filtering part 310. Accordingly, it will be understood that the raw water flow (R.F) passes through the sub-filtering part 320 in any one direction of the radial outer space and extends into the flow space 313.

Since the subsequent flow process of raw water, living water, and purified water is the same as the flow process inside the filter structure 10 according to the above-described embodiment, the following description will be replaced with the above-described description.

Therefore, the filter structure 20 according to the present embodiment also allows raw water to pass through the sub-filtering part 320 as well as one end in the height direction of the filtering part 303, that is, the lower end in the illustrated embodiment and to flow into the flow space 313 in the radial direction as well.

Accordingly, a plurality of raw water flows (R.F) are formed so that the flow path of raw water can be diversified, and the flow efficiency of raw water can be improved. Furthermore, foreign substances separated from raw water can be distributed over a wider space, thereby reducing the concentration of foreign substances staying in any space. As a result, the service life of the filter structure 20 and the cleanliness of the filtered purified water can be further improved.

The filter structure 10, 20 according to an exemplary embodiment of the present invention can form the raw water flow (R.F) in various directions through the above-described configuration. Accordingly, the flow direction of raw water can be diversified and filtration efficiency can be improved.

In addition, as the flow direction of raw water diversifies, the space where foreign substances separated from raw water reside can also diversify. Therefore, the concentration of foreign substances staying in any space can be lowered, thereby minimizing damage to the filter member 300 caused by foreign substances.

Therefore, the same amount of foreign substances from raw water can be spread out and distributed over a wider space, thereby lowering the concentration of foreign substances remaining in each space. As a result, compared to the case where foreign substances are densely distributed, raw water, living water, or purified water can flow more smoothly.

In addition, when the concentration of foreign substances in a specific space inside the filter member 300 is excessively high, the TDS creep phenomenon in which the foreign substances flow toward the purified water to balance the concentration can also be prevented.

Furthermore, washing water applied to remove foreign substances remaining inside the filter member 300 may also flow into the filter member 300 in various directions, that is, in the longitudinal and radial directions of the filter member 300. Accordingly, the cleaning efficiency of the filter member 300 can also be improved.

Furthermore, as the cleaning efficiency of the filter member 300 improves, the amount of foreign substances remaining inside the filter member 300 is further reduced. As a result, the effect of preventing the TDS creep phenomenon can also be further improved.

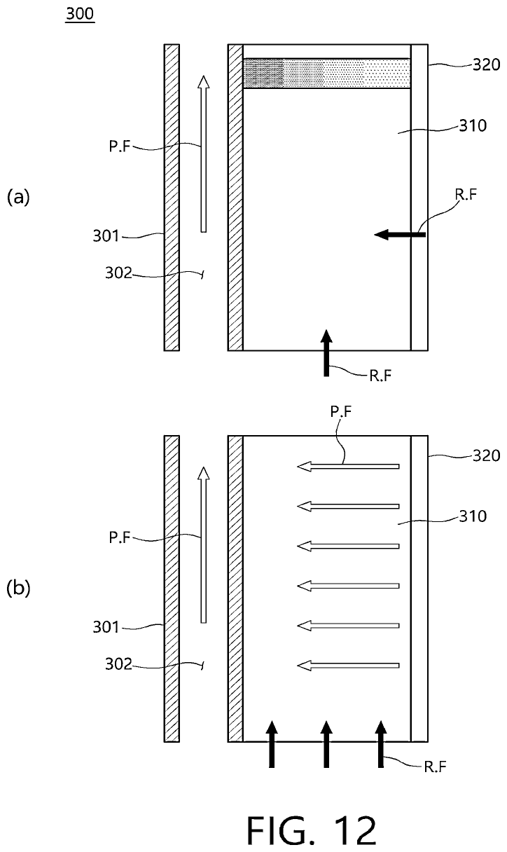

Hereinafter, the effects of the filter structure 10, 20 according to an exemplary embodiment of the present invention will be described in detail with reference to FIG. 12.

Referring to (a) of FIG. 12, the raw water flow (R.F) formed inside the filter structure 10, 20 according to an exemplary embodiment of the present invention and the distribution state of foreign substances separated from the raw water are illustrated.

As described above, the raw water flow (R.F) may extend into the interior of the main filtering part 310 through the lower end of the filter member 300.

The introduced raw water flows along the flow space 313 and is filtered to produce purified water.

In this case, the raw water flow (R.F) may extend to the inside of the main filtering part 310 through the sub-filtering part 320 even from the radial outside of the filter member 300. Raw water introduced in the above direction also flows along the flow space 313 and is filtered to produce purified water.

As filtration of raw water progresses, foreign substances accumulate inside the main filtering part 310 on the downstream side of the raw water flow (R.F).

Meanwhile, as the raw water flow (R.F) extends in various directions, the flow rate of raw water flowing inside the main filtering part 310 for a predetermined time increases. Accordingly, foreign substances accumulated inside the filter member 300 are spread out and distributed over a wider space.

That is, the accumulated foreign substances may not be distributed along the direction in which the filter member 300 extends (i.e., up-down direction), but may be spread out and distributed in other directions as well. Specifically, the accumulated foreign substances are pushed by the raw water and distributed on the downstream side of one raw water flow (R.F), that is, on the upper side of the main filtering part 310 in the illustrated embodiment.

Referring to (b) of FIG. 12, a purified water flow (P.F) formed inside the filter structure 10, 20 according to an exemplary embodiment of the present invention is shown.

As described above, foreign substances separated from the raw water are mainly distributed adjacent to the upper end of the main filtering part 310. Therefore, the purified water flow (P.F) inside the main filtering part 310 is minimally affected by foreign substances, so that purified water may flow smoothly.

Therefore, the flow rate of the purified water flow (P.F) formed in the flow space 313 along the longitudinal direction of the filter member 300, that is, in the up-down direction in the illustrated embodiment, may be formed to be constant.

As a result, foreign substances separated from raw water can be spread out and distributed over a wider space within the filter structure 10, 20. In other words, the concentration of foreign substances remaining in a specific space is reduced, and the effect of preventing the TDS creep phenomenon can be improved. Furthermore, the effectiveness of the cleaning process to remove remaining foreign substances is also improved, so the reliability of the filter structure 10, 20 can be improved and maintenance can be simplified.

Although the above has been described with reference to preferred embodiments of the present invention, it will be understood that those skilled in the art can variously modify and change the present invention without departing from the idea and scope of the present invention described in the claims below.

### DESCRIPTION OF SYMBOLS

1: water purifier
10, 20: filter structure
30: raw water supply unit
40: purified water discharge unit
60: valve unit
70: control unit
100: housing
110: housing opening
120: accommodation space
130: blocking member
200: conduit unit
210: inlet conduit
220: outlet conduit
300: filter member
301: cylinder part
302: filter hollow part
303: filtering part
304: filtering part
310: main filtering part
311: first main end
312: second main end
313: flow space
320: sub-filtering part
321: first sub-end
322: second sub-end
323: opening
324: rib
1000: filter member according to the related art
1100: cylinder
1200: valve
R.F: raw water flow
L.F: living water flow
P.F: purified water flow
a: contained angle

What is claimed is:

1. A filter member, comprising:
a cylinder part extending in one direction;
a filter hollow part which is formed inside the cylinder part to pass through along the one direction and allows the inside of the cylinder part to be in communication along the one direction; and
a filtering part disposed to surround the cylinder part from radially outside and configured to filter raw water flowing through the filter hollow part,
wherein the filtering part comprises:
a main filtering part which has one end coupled to the outer circumferential surface of the cylinder part and extends from the one end toward the other end and which is wound at least one time along the outer circumferential surface of the cylinder part to surround the outer circumferential surface of the cylinder part; and
a sub-filtering part which has one end coupled to the other end of the main filtering part and extends from the one end toward the other end and which is wound along the outer circumference of the main filtering part to surround the outer circumference of the main filtering part,
wherein the sub-filtering part comprises a plurality of openings forming passages which the raw water passes through to enter the main filtering part.

2. The filter member of claim 1, wherein the sub-filtering part comprises a plurality of ribs surrounding the plurality of openings.

3. The filter member of claim 2, wherein among the plurality of ribs, adjacent ribs are spaced apart from each other and extend in parallel.

4. The filter member of claim 2,
wherein a portion of the plurality of ribs extend along the one direction in which the cylinder part extends,
the other portion of the plurality of ribs extend along the outer circumferential direction of the cylinder part, and
among the plurality of ribs, the portion and the other portion are formed to intersect each other at a predetermined angle.

5. The filter member of claim 1,
wherein the sub-filtering part comprises:
a first sub-end coupled to the other end of the main filtering part; and
a second sub-end continuous with the first sub-end and located radially outside the first sub-end, and
wherein the sub-filtering part is wound around the main filtering part so that the first sub-end and the second sub-end are coupled.

6. The filter member of claim 1,
wherein the length of the sub-filtering part in the outer circumferential direction is formed to be less than or equal to the length of the main filtering part in the outer circumferential direction,
the sub-filtering part is formed of a material with a predetermined elongation rate, and
the sub-filtering part presses the main filtering part radially inward and is wound around the main filtering part.

7. The filter member of claim 1,
wherein the plurality of openings are formed to have a diameter smaller than the diameter of any foreign substances mixed in the raw water, and
when the raw water passes through the sub-filtering part, any foreign substances stay radially outside the sub-filtering part.

8. The filter member of claim 1,
wherein a plurality of the main filtering parts are provided, and the plurality of main filtering parts are spaced apart from each other along the outer circumferential direction of the cylinder part at a predetermined angle, and
the sub-filtering part is coupled to the other end of any one of the plurality of main filtering parts.

9. The filter member of claim 8, wherein among the plurality of main filtering parts, an angle between a pair of main filtering parts adjacent to each other is the same as an angle between another pair of adjacent main filtering parts adjacent to each other.

10. The filter member of claim 8, wherein the plurality of main filtering parts are spaced apart along the outer circumferential direction of the cylinder part while forming the same angle as each other.

11. The filter member of claim 1,
wherein the main filtering part is provided in single pieces and is wound around the cylinder part at least once to surround the outer circumferential surface of the cylinder part, and
the sub-filtering part extends from the other end of the main filtering part and is wound around the cylinder part to surround the outer circumference of the single main filtering part.

12. The filter member of claim 1, wherein the raw water is introduced into the main filtering part along the one direction in which the cylinder part extends and the radial direction of the cylinder part, flows toward the filter hollow part, and is filtered.

13. A filter structure, comprising:
a housing having an accommodation space formed therein that communicates with the outside;
a filter member accommodated in the accommodation space of the housing and configured to filter raw water delivered from the outside to produce purified water or living water; and
a conduit unit extending in one direction and communicating the accommodation space and the filter member accommodated in the accommodation space with the outside,
wherein the filter member comprises:
a cylinder part extending in the one direction;
a filter hollow part formed through the inside of the cylinder part along the one direction, a portion of which communicates with the conduit unit and the accommodation space; and
a filtering part disposed to surround the cylinder part from radially outside and configured to filter raw water flowing through the filter hollow part,
wherein the conduit unit comprises:
an inlet conduit extending through the portion of the filter hollow part and communicating with the accommodation space; and
an outlet conduit accommodated in the remaining portion of the filter hollow part, and communicating with the filter part, but being blocked from communication with the accommodation space and the inlet conduit,
wherein the filtering part comprises:
a main filtering part arranged to surround the outer circumferential surface of the cylinder part; and
a sub-filtering part arranged to surround the outer circumferential surface of the main filtering part and having a plurality of openings formed therethrough in communication with the accommodation space, and
wherein the raw water delivered to the accommodation space sequentially passes through the sub-filtering part and the main filtering part and flows toward the outlet conduit.

14. The filter structure of claim 13,
wherein the main filtering part has one end coupled to the outer circumferential surface of the cylinder part and is wound around the cylinder part, and
the sub-filtering part is coupled to the other end of the main filtering part and is arranged to wind the main filtering part wound around the cylinder part.

15. The filter structure of claim 13,
wherein a portion of the raw water delivered to the accommodation space is introduced into the main filtering part through one end surface of the main filtering part along the one direction, and
the remaining portion of the raw water delivered to the accommodation space passes through the sub-filtering part from the radial outside of the sub-filtering part and is introduced into the main filtering part.

16. The filter structure of claim 13,
wherein a plurality of the main filtering parts are provided, and the plurality of main filtering parts are spaced apart from each other at a predetermined angle in the outer circumferential direction of the cylinder part, and
the sub-filtering part is coupled to one or more of the plurality of main filtering parts.
